(19) United States
(12) Patent Application Publication
(10) Pub. No.: US 2007/0094262 A1
(43) Pub. Date: Apr. 26, 2007

(54) SERVER, VEHICLE-MOUNTED NAVIGATION APPARATUS, VEHICLE EMPLOYING THESE, AND PARTICULAR INFORMATION DISTRIBUTION SYSTEM RELATED TO THESE

(75) Inventors: Atsuyuki Suzuki, Wako-shi, Saitama (JP); Shinichirou Goto, Wako-shi, Saitama (JP); Hitoshi Konishi, Wako-shi, Saitama (JP); Tadafumi Nogawa, Wako-shi, Saitama (JP)

Correspondence Address: RANKIN, HILL, PORTER & CLARK LLP, 4080 ERIE STREET, WILLOUGHBY, OH, 44094-7836, US

(73) Assignee: HONDA MOTOR CO., LTD., Tokyo (JP)

(21) Appl. No.: 11/538,292

(22) Filed: Oct. 3, 2006

(30) Foreign Application Priority Data
Oct. 5, 2005 (JP) 2005-292932

(51) Int. Cl. G06F 17/30

(52) U.S. Cl. 707/9

(57) ABSTRACT

A server generates area-specific particular information beforehand, and obtains positional information and route information from a vehicle-mounted navigation apparatus or a vehicle. The server determines particular information to be sent to the vehicle-mounted navigation apparatus or whether a warning is necessary, for each area segment including location indicated by the positional information and/or the route information. The server then distributes necessary particular information or area-specific threshold data. The vehicle-mounted navigation apparatus receives the information from the server, determines whether or not a warning is necessary in the area segment of the present position of the vehicle using the area-specific threshold data, and displays the particular information or the warning.

This application is based on and claims the benefit of priority from Japanese Patent Application No. 2005-292932, filed on 5 Oct. 2005, the content of which is incorporated herein by reference.

### BACKGROUND OF THE INVENTION

1. Field of the Invention

The present invention relates to a server that distributes warning information, and a vehicle-mounted navigation apparatus, a vehicle, and a particular information distribution system that display warnings corresponding to the present position of the vehicle.

2. Related Art

There is a method for distributing meteorological information to navigation apparatuses. For example, in one system, a content provider receives meteorological information obtained from meteorological satellites, the Automated Meteorological Data Acquisition System (AMeDAS), or the like, from the Japan Weather Association, and distributes nation-wide information to navigation apparatuses as it is. Furthermore, Japanese Unexamined Patent Publication No. 2002-44289 discloses a technique in which a terminal that is capable of independently observing weather is installed in each area or moving body for obtaining local meteorological information and meteorological information for a certain region, and is distributed in addition to wide-area meteorological information, such as the AMeDAS data.

However, when the meteorological data obtained from the meteorological satellites, the AMeDAS, or the like, is distributed to the whole nation as it is, the size of the data distributed tends to be increased because wide-area meteorological data is distributed. As a result, when the data is received by a vehicle-mounted navigation apparatus, a lot of communication time and communication fees are required for receiving it, making the method inappropriate. Furthermore, weather advisories, warnings, or the like, that are distributed, are issued based on criteria which are different from area to area. In general, however, update of such area-specific criteria is infrequent. As a result, weather warnings or the like which are appropriate for that area may not be always issued.

On the contrary, in the technique disclosed in Japanese Unexamined Patent Publication No. 2002-44289, meteorological information on a specific region can be obtained by a moving body. However, with this technique, only meteorological information of the area in which the moving body is present, is obtained, and accordingly, no information can be obtained in areas in which moving bodies are absent. Furthermore, since no information on warnings or the like is provided to the user, the user has to make a decision as to whether or not the user should be cautious based on the meteorological information.

In addition, rainfall and snowfall warnings are different from area to area or from season to season, and the warning levels for the same rainfall or snowfall are generally different in different areas. For example, in the metropolitan area including Tokyo, the public transportation and traffic systems are often disrupted by a snowfall of about 2 cm/hour, whereas in snow belt areas, such as in Niigata, no special caution may be required for a snowfall of about 2 cm/hour. Furthermore, when a certain area is affected by localized torrential rain or a large-scale earthquake or the like, no warning is necessary for people traveling in areas distant from the affected area but a warning is necessary for people traveling in that area. As described above, what is desired is displaying messages, such as warnings, that are suited to the area or the season, to the driver while driving, for providing more appropriate information, thereby encouraging safer driving.

### SUMMARY OF THE INVENTION

An object of the present invention is to provide a server, a vehicle-mounted navigation apparatus, a vehicle, and a particular information distribution system that can provide appropriate indications on the vehicle-mounted navigation apparatus according to the area, the season, the type of disaster, or the like, in an area that requires caution for driving, thereby encouraging safer driving while reducing the size of the data to be distributed.

In order to solve the above-described problems, the present invention provides a server, a vehicle-mounted navigation apparatus, a vehicle, and a particular information distribution system as follows.

In a first aspect of the invention, a server that is capable of communicating with a vehicle, is provided, the server including: a particular information storage device that stores particular information; an area-specific particular information storage device that stores area-specific particular information, the area-specific particular information associating the particular information with an area segment; a vehicle information reception device that receives at least one of positional information and route information of the vehicle; an area-specific threshold data extraction device that extracts area-specific threshold data of a corresponding area segment from the area-specific particular information based on the information received by the vehicle information reception device; a warning necessity determination device that determines whether or not a warning is necessary based on the area-specific threshold data and the particular information; a navigation assisting data generation device that generates navigation assisting data containing the warning necessity information determined by the warning necessity determination device and the area-specific particular information; and a transmission device that sends the navigation assisting data to the vehicle.

According to the first aspect of the invention, the particular information storage device is shown as a particular information storage unit 28 that is shown in FIG. 2, for example, and stores particular information. The area-specific particular information storage device is shown as an area-specific data database 22 that is shown in FIG. 2, for example, and stores area-specific particular information that associates the particular information with an area segment. The vehicle information reception device is shown as a communication unit 20 that is shown in FIG. 2, for example, and receives the positional information and/or the route information of the vehicle. The area-specific threshold data extraction device is shown as an area-specific threshold data extraction unit 16 that is shown in FIG. 2, for example, and extracts area-specific threshold data of the corresponding area segment from the area-specific particular information based on the positional information and/or the route information. The warning necessity determination device is shown as a warning necessity definition unit 17 that is shown in FIG. 2, for example, and determines whether or not a warning is necessary based on the area-specific threshold data and the particular information. The navigation assisting data generation device is shown as a navigation assisting data generation unit 13 that is shown in FIG. 2, for example, and generates navigation assisting data containing the warning necessity information determined by the warning necessity determination device and the area-specific particular information. The transmission device is shown as a communication unit 20 that is shown in FIG. 2, for example, and sends the navigation assisting data to the vehicle.

According to the above-described structure, the server of the present invention stores area-specific particular information that associates particular information that it has received with certain area segments beforehand. The server then extracts area-specific threshold data of the corresponding area based on the positional information and/or the route information of the vehicle-mounted navigation apparatus. The warning necessity determination device then determines whether or not a warning is necessary based on the area-specific threshold data and generates warning necessity information. The navigation assisting data generation device then generates navigation assisting data containing the area-specific particular information and the warning necessity information.

According to the above-described structure, since the server of the present invention simply has to send data of limited regions, reduction of communication time and communication fees can be expected, as compared to cases in which nationwide information is sent. Furthermore, it becomes possible to extract an area segment in the present position of the vehicle or en route to the destination, thereby providing information appropriate for that area segment. As a result, a server that can encourage safer driving by providing the vehicle with appropriate information can be realized.

In a second aspect of the invention, a server that is capable of communicating with a vehicle is provided, the server including: a particular information storage device that stores particular information; an area-specific particular information storage device that stores area-specific particular information, the area-specific particular information associating the particular information with an area segment; a vehicle information reception device that receives at least one of positional information and route information of the vehicle; an area-specific threshold data extraction device that extracts area-specific threshold data of a corresponding area segment from the area-specific particular information based on the information received by the vehicle information reception device; a navigation assisting data generation device that generates navigation assisting data containing the area-specific particular information and the area-specific threshold data; and a transmission device that sends the navigation assisting data to the vehicle.

According to the second aspect of the invention, the particular information storage device is shown as a particular information storage unit 28 that is shown in FIG. 2, for example, and stores particular information. The area-specific particular information storage device is shown as an area-specific data database 22 that is shown in FIG. 2, for example, and stores area-specific particular information that associates the particular information with an area segment. The vehicle information reception device is shown as a communication unit 20 that is shown in FIG. 2, for example, and receives the positional information and/or the route information of the vehicle. The area-specific threshold data extraction device is shown as an area-specific threshold data extraction unit 16 that is shown in FIG. 2, for example, and extracts area-specific threshold data of the corresponding area segment from the area-specific particular information based on the positional information and/or the route information. The navigation assisting data generation device is shown as a navigation assisting data generation unit 13 that is shown in FIG. 2, for example, and generates navigation assisting data containing the area-specific particular information and the area-specific threshold data. The transmission device is shown as a communication unit 20 that is shown in FIG. 2, for example, and sends the navigation assisting data to the vehicle.

According to the above-described structure, since the server simply has to send data of limited regions, reduction of communication time and communication fees can be expected, as compared to cases in which nationwide information is sent. Furthermore, it becomes possible to extract an area segment in the present position of the vehicle or en route to the destination, thereby providing information appropriate for that area segment. By this, a server that can encourage safer driving by providing the vehicle with appropriate information can be realized.

In a third aspect of the invention, a server according to the first or second aspects is provided, wherein the particular information is meteorological information.

According to the third aspect of the invention, since the particular information that is received by the server and is sent to the vehicle-mounted navigation apparatus for each area segment is meteorological information, it becomes possible to send meteorological information of each area segment. By this, information related to an area segment in the present position of the vehicle or on the route can be provided about different weather conditions and weather warnings or advisories across the nation. As a result, a server that can encourage safer driving by providing the vehicle with appropriate information can be realized.

In a fourth aspect of the invention, a server according to any one of the above first to third aspects id provided, wherein a navigation apparatus information reception device of the server, in response to the vehicle connecting to the server via a communication device and making a distribution request for the navigation assisting data to the server, receives the distribution request from the vehicle, and sends, by the transmission device, the navigation assisting data generated by the navigation assisting data generation device.

According the fourth aspect of the invention, the vehicle makes the distribution request of the navigation assisting data to server. On the server side, once the navigation apparatus information reception device receives the distribution request, the navigation assisting data generation device generates new navigation assisting data and sends it to the vehicle.

By this, since the server generates the navigation assisting data and send it to the vehicle after receiving the distribution request, it can generate navigation assisting data from up-to-date particular information. Especially during a long-time driving, the vehicle can obtain new particular information that often changes over time every time it makes a request. As a result, a server that can encourage safer driving by providing the vehicle with appropriate information can be realized.

In a fifth aspect of the invention, a vehicle-mounted navigation apparatus is provided for searching for a route corresponding to a destination of a vehicle, displaying map data on a display device, and providing a route navigation, the apparatus including: a position determination device that can determine a present position of the vehicle; a communication device that communicates with the server; a server information storage device that stores navigation assisting data containing area-specific threshold data for each area segment for determining whether or not a warning is necessary and area-specific particular information for the each area segment, that are sent by the server and received by the communication device; a warning necessity determination device that determines whether or not the warning is required based on the area-specific threshold data and the area-specific particular information that are stored in the server information storage device; and a warning-related output control device that controls at least one of a display of a symbol and an output of sound related to the warning, based on the determination made by the warning necessity determination device.

According to the fifth aspect of the invention, the position determination device is shown as a GPS reception unit 42 that is shown in FIG. 3, for example, and can determine the present position of the vehicle. The communication device is shown as a communication unit 44 that is shown in FIG. 3, for example, and communicates with the server. The server information storage device is shown as a server information storage unit 46 that is shown in FIG. 3, for example, and stores navigation assisting data containing area-specific threshold data for each area segment for determining whether or not a warning is necessary and area-specific particular information for the each area segment that are sent by the server and received by the communication device. The warning necessity determination device is shown as a warning necessity definition unit 38 that is shown in FIG. 3, for example, and determines whether or not the warning is required based on the area-specific threshold data and the area-specific particular information stored in the server information storage device. The warning-related output control device is shown as a symbol display control unit 36 and/or a sound output unit 50 that are shown in FIG. 3, for example, and controls a display of a symbol and/or an output of sound related to the warning based on the determination made by the warning necessity determination device.

According to the above-described structure, even when the vehicle travels a long distance, it becomes possible to provide a warning or the like that is appropriate for the area segment in which the present position of the vehicle is located. In other words, a vehicle-mounted navigation apparatus that can encourage safer driving of the vehicle by obtaining appropriate information can be realized.

In a sixth aspect of the invention, a vehicle-mounted navigation apparatus is provided for searching for a route corresponding to a destination of a vehicle, displaying map data on a display device, and providing a route navigation, the apparatus including: a position determination device that can determine a present position of the vehicle; a communication device that communicates with the server; a server information storage device that stores navigation assisting data containing area-specific threshold data for each area segment for determining whether or not a warning is necessary and area-specific particular information for the each area segment, that are sent by the server and received by the communication device; a warning-related output control device that controls at least one of a display of a symbol and an output of sound related to the warning based on warning necessity information that is stored in the server information storage device.

According to the sixth aspect of the invention, the position determination device is shown as a GPS reception unit 42 that is shown in FIG. 3, for example, and can determine the present position of the vehicle. The communication device is shown as a communication unit 44 that is shown in FIG. 3, for example, and communicates with the server. The server information storage device is shown as the storage unit 46 that is shown in FIG. 3, for example, and stores navigation assisting data containing warning necessity information that is associated with a determination made by the server as to whether or not a warning is necessary and area-specific particular information for each area segment that are sent by the server and received by the communication device. The warning-related output control device is shown as a symbol display control unit 36 and/or a sound output unit 50 that are shown in FIG. 3, for example, and controls a display of a symbol and/or an output of sound associated the warning based on the warning necessity information that is stored in the server information storage device.

According to the above-described structure, when a warning is necessary in the area segment in which the present position of the vehicle is located based on the warning necessity information contained in the navigation assisting data that has been received from the server, a corresponding warning symbol is displayed or an audio warning is output. Alternatively, the warning symbol may be displayed while the warning is output as a sound.

By this, even when the vehicle travels a long distance, it becomes possible to provide a warning or the like that is appropriate for the area segment in which the present position of the vehicle is located. In other words, a vehicle-mounted navigation apparatus that can encourage safer driving of the vehicle by obtaining appropriate information can be realized.

In a seventh aspect of the invention, a vehicle-mounted navigation apparatus according to the above fifth or sixth aspects is provided, wherein the area-specific particular information is meteorological information for each area segment.

According to the seventh aspect of the invention, since the area-specific particular information received from the server is meteorological information, it becomes possible to receive meteorological information of each area segment for displaying it on the vehicle-mounted navigation apparatus or outputting it as a sound.

By this, information related to an area segment in the present position of the vehicle or on the route can be provided by the vehicle-mounted navigation apparatus to the vehicle about different weather conditions and weather warnings or advisories across the nation. In other words, a vehicle-mounted navigation apparatus that can encourage safer driving of the vehicle by obtaining appropriate information can be realized.

In an eighth aspect of the invention, a vehicle is provided for searching for a route corresponding to a destination of the vehicle, displaying map data on a display device, and providing route navigation, the vehicle including: a position determination device that can determine a present position of the vehicle; a communication device that communicates with the server; a server information storage device that stores navigation assisting data containing area-specific threshold data for each area segment for determining whether or not a warning is necessary and area-specific particular information for the each area segment that are sent by the server and received by the communication device; a warning necessity determination device that determines whether or not the warning is required based on the area-specific threshold data and the area-specific particular information that are stored in the server information storage device; and a warning-related output control device that controls at least one of a display of a symbol and an output of sound related to the warning, based on the determination made by the warning necessity determination device.

According to the eighth aspect of the invention, the position determination device is shown as a GPS reception unit 42 that is shown in FIG. 3, for example, and can determine the present position of the vehicle. The communication device is shown as a communication unit 44 that is shown in FIG. 3, for example, and communicates with the server. The server information storage device is shown as a server information storage unit 46 that is shown in FIG. 3, for example, and stores navigation assisting data containing area-specific threshold data for each area segment for determining whether or not a warning is necessary and area-specific particular information for the each area segment that are sent by the server and received by the communication device. The warning necessity determination device is shown as a warning necessity definition unit 38 that is shown in FIG. 3, for example, and determines whether or not the warning is required based on the area-specific threshold data and the area-specific particular information stored in the server information storage device. The warning-related output control device is shown as a symbol display control unit 36 and/or a sound output unit 50 that are shown in FIG. 3, for example, and controls a display of a symbol and/or an output of sound related to the warning based on the determination made by the warning necessity determination device.

According to the above-described structure, the vehicle determines by means of the warning necessity determination device as to whether or not a warning is necessary based on the area-specific particular information and the area-specific threshold data contained in the navigation assisting data that has been received from the server in the area segment in which the present position of the vehicle is located. When a warning is necessary, a corresponding warning symbol is displayed or an audio warning is output. Alternatively, the warning symbol may be displayed while the warning is output as a sound.

By this, even when the vehicle travels a long distance, it becomes possible for the vehicle to provide a warning or the like that is appropriate for the area segment in which the present position of the vehicle is located. As a result, a vehicle that can encourage safer driving by obtaining appropriate information can be realized.

In a ninth aspect of the invention, a vehicle is provided for searching for a route corresponding to a destination of the vehicle, displaying map data on a display device, and providing route navigation, the vehicle including: a position determination device that can determine a present position of the vehicle; a communication device that communicates with the server; a server information storage device that stores navigation assisting data containing warning necessity information by which the server determines whether or not a warning is necessary, and area-specific particular information for each area segment, that are sent by the server and received by the communication device; and a warning-related output control device that controls at least one of a symbol display for displaying a symbol and sound output related to the warning, based on the warning necessity information that is stored in the server information storage device.

According to the ninth aspect of the invention, when a warning is necessary in the area segment in which the present position of the vehicle is located based on the warning necessity information contained in the navigation assisting data that has been received from the server, a corresponding warning symbol is displayed or an audio warning is output. Alternatively, the warning symbol may be displayed while the warning is output as a sound.

By this, even when the vehicle travels a long distance, it becomes possible for the vehicle to provide a warning or the like that is appropriate for the area segment in which the present position of the vehicle is located. On other words, a vehicle that can encourage safer driving by obtaining appropriate information can be realized.

In a tenth aspect of the invention a vehicle according to the above eighth or ninth aspects is provided, wherein the area-specific particular information is meteorological information for each area segment.

According to the tenth aspect of the invention, since the area-specific particular information received from the server is meteorological information, it becomes possible to receive meteorological information of each area segment for displaying it on the vehicle-mounted navigation apparatus or outputting it as a sound.

By this, information related to an area segment in the present position of the vehicle or on the route can be provided about different weather conditions and weather warnings or advisories across the nation. As a result, a vehicle that can encourage safer driving by obtaining appropriate information can be realized.

In an eleventh aspect of the invention, a particular information distribution system is provided, including a server and a vehicle, the server and the vehicle being capable of communicating each other, the server including: a particular information storage device that stores particular information; an area-specific particular information storage device that stores area-specific particular information, the area-specific particular information associating the particular information with an area segment; a vehicle information reception device that receives at least one of positional information and route information of the vehicle; an area-specific threshold data extraction device that extracts area-specific threshold data of a corresponding area segment from the area-specific particular information based on the information corresponding to the reception by the vehicle information reception device; a warning necessity determination device that determines whether or not a warning is necessary based on the area-specific threshold data and the particular information; a navigation assisting data generation device that generates navigation assisting data containing the warning necessity information determined by the warning necessity determination device and the area-specific particular information; and a transmission device that sends the navigation assisting data to the vehicle, and the vehicle including: a position determination device that can determine a present position of the vehicle; a communication device that communicates with the server; a server information storage device that stores the navigation assisting data received from the server; and a warning-related output control device that controls at least one of a display of a symbol and an output of sound related to the warning, based on warning necessity information that is stored in the server information storage device.

According to the eleventh aspect of the invention, in the server, the particular information storage device is shown as a particular information storage unit 28 that is shown in FIG. 2, for example, and stores particular information. The area-specific particular information storage device is shown as an area-specific data database 22 that is shown in FIG. 2, for example, and stores area-specific particular information that associates the particular information with an area segment. The vehicle information reception device is shown as a communication unit 20 that is shown in FIG. 2, for example, and receives the positional information and/or the route information of the vehicle. The area-specific threshold data extraction device is shown as an area-specific threshold data extraction unit 16 that is shown in FIG. 2, for example, and extracts area-specific threshold data of the corresponding area segment from the area-specific particular information based on the positional information and/or the route information. The warning necessity determination device is shown as a warning necessity definition unit 17 that is shown in FIG. 2, for example, and determines whether or not a warning is necessary based on the area-specific threshold data and the particular information. The navigation assisting data generation device is shown as a navigation assisting data generation unit 13 that is shown in FIG. 2, for example, and generates navigation assisting data containing the warning necessity information determined by the warning necessity determination device and the area-specific particular information. The transmission device is shown as a communication unit 20 that is shown in FIG. 2, for example, and sends the navigation assisting data to the vehicle.

Furthermore, in the vehicle, the position determination device is shown as a GPS reception unit 42 that is shown in FIG. 3, for example, and can determine the present position of the vehicle. The communication device is shown as a communication unit 44 that is shown in FIG. 3, for example, and communicates with the server. The server information storage device is shown as a server information storage unit 46 that is shown in FIG. 3, for example, and stores navigation assisting data containing area-specific threshold data for each area segment for determining whether or not a warning is necessary and area-specific particular information for the each area segment that are sent by the server and received by the communication device. The warning necessity determination device is shown as a warning necessity definition unit 38 that is shown in FIG. 3, for example, and determines whether or not the warning is required based on the area-specific threshold data and the area-specific particular information stored in the server information storage device. The warning-related output control device is shown as a symbol display control unit 36 and/or a sound output unit 50 that are shown in FIG. 3, for example, and controls a display of a symbol and/or an output of sound related to the warning based on the determination made by the warning necessity determination device.

According to the above-described structure, the server stores area-specific particular information by classifying particular information for each area segment, generates navigation assisting data containing the area-specific particular information that is related to the route information and the warning necessity information, and distributes them to the vehicle-mounted navigation apparatus. Upon reception, the vehicle displays a warning symbol or outputs a warning as a sound when a warning is necessary based on the warning necessity information contained in the navigation assisting data. By this, it becomes possible for the server to provide information appropriate for the area segment where the vehicle is traveling while keeping the data size small since the server distributes particular information appropriate for a certain area segment to the vehicle. In other words, a particular information distribution system that can provide with the vehicle appropriate information and encourage safer driving can be provided.

In a twelfth aspect of the invention, a particular information distribution system is provided, including a server and a vehicle, the server and the vehicle being capable of communicating each other, the server including: a particular information storage device that stores particular information; an area-specific particular information storage device that stores area-specific particular information, the area-specific particular information associating the particular information with an area segment; a vehicle information reception device that receives at least one of positional information and route information of the vehicle; an area-specific threshold data extraction device that extracts area-specific threshold data of a corresponding area segment from the area-specific particular information based on the reception by the vehicle information reception device; a navigation assisting data generation device that generates navigation assisting data containing the area-specific particular information and the area-specific threshold data; and a transmission device that sends the navigation assisting data to the vehicle, and the vehicle including: a position determination device that can determine a present position of the vehicle; a communication device that communicates with the server; a server information storage device that stores the navigation assisting data received from the server; and a warning necessity determination device that determines whether or not a warning is necessary based on the area-specific threshold data and the area-specific particular information that are stored in the server information storage device; and a warning-related output control device that controls at least one of a display of a symbol and an output of sound related to the warning based on the determination made by the warning necessity determination device.

According to the twelfth aspect of the invention, in the server, the particular information storage device is shown as a particular information storage unit 28 that is shown in FIG. 2, for example, and stores particular information. The area-specific particular information storage device is shown as an area-specific data database 22 that is shown in FIG. 2, for example, and stores area-specific particular information that associates the particular information with an area segment. The vehicle information reception device is shown as a communication unit 20 that is shown in FIG. 2, for example, and receives the positional information and/or the route information of the vehicle. The area-specific threshold data extraction device is shown as an area-specific threshold data extraction unit 16 that is shown in FIG. 2, for example, and extracts area-specific threshold data of the corresponding area segment from the area-specific particular information based on the positional information and/or the route information. The navigation assisting data generation device is shown as a navigation assisting data generation unit 13 that is shown in FIG. 2, for example, and generates navigation assisting data containing the warning necessity information determined by the warning necessity determination device and the area-specific particular information. The transmission device is shown as a communication unit 20 that is shown in FIG. 2, for example, and sends the navigation assisting data to the vehicle.

Furthermore, in the vehicle, the position determination device is shown as a GPS reception unit 42 that is shown in FIG. 3, for example, and can determine the present position of the vehicle. The communication device is shown as a communication unit 44 that is shown in FIG. 3, for example, and communicates with the server. The server information storage device is shown as a storage unit 46 that is shown in FIG. 3, for example, and stores the navigation assisting data received from the server. The warning necessity determination device is shown as a warning necessity definition unit 38 that is shown in FIG. 3, for example, and determines whether or not a warning is necessary based on the area-specific threshold data and the area-specific particular information that are stored in the server information storage device. The warning-related output control device is shown as a symbol display control unit 36 and/or a sound output unit 50 that are shown in FIG. 3, for example, and controls a display of a symbol and/or an output of sound related to the warning based on the determination made by the warning necessity determination device.

According to the above-described structure, the server stores area-specific particular information by classifying particular information for each area segment, generates navigation assisting data containing the area-specific particular information that is related to the positional information or the route information of the vehicle and the area-specific threshold data, and distributes it to the vehicle. Upon reception, the vehicle determines whether or not a warning is necessary by the warning necessity determination device based on the area-specific particular information and the area-specific threshold data, and displays a warning symbol related to the corresponding area segment. By this, it becomes possible to provide information appropriate for the area segment where the vehicle is traveling while keeping the data size small since the server distributes particular information appropriate for a certain area segment to the vehicle. In other words, a particular information distribution system that can provide with the vehicle appropriate information and encourage safer driving can be provided.

The above-described present invention provides a server that can provide with a vehicle-mounted navigation apparatus and/or a vehicle warnings or the like that is suited to the area where the vehicle is traveling or the destination thereof, or suited to the season or occurrence of a disaster, a vehicle-mounted navigation apparatus, a vehicle employing these, and a particular information distribution system relating to these.

### BRIEF DESCRIPTION OF THE DRAWINGS

FIG. 1 is a block diagram illustrating a schematic structure of a system including a server, a vehicle-mounted navigation apparatus, and a vehicle according to an example of a preferred embodiment of the present invention;

FIG. 2 is a block diagram illustrating a schematic structure of the server according to an example of a preferred embodiment of the present invention;

FIG. 3 is a block diagram illustrating a schematic structure of the vehicle-mounted navigation apparatus or the vehicle according to an example of a preferred embodiment of the present invention;

FIG. 4 is a schematic diagram illustrating an example of area-specific threshold data according to an example of a preferred embodiment of the present invention;

FIG. 5 is a flowchart showing a flow of processes in the vehicle-mounted navigation apparatus or the vehicle or according to an example of a preferred embodiment of the present invention;

FIG. 6 is a flowchart showing a flow of processes in the server and in the vehicle-mounted navigation apparatus or the vehicle according to an example of a preferred embodiment of the present invention;

FIG. 7 is a conceptual diagram showing processes in the server and in the vehicle-mounted navigation apparatus or the vehicle according to an example of a preferred embodiment of the present invention;

FIG. 8 is a diagram illustrating an example of display of warning symbols on the vehicle-mounted navigation apparatus or the vehicle according to an example of a preferred embodiment of the present invention;

FIG. 9 is a diagram illustrating an example of display of warning symbols on the vehicle-mounted navigation apparatus or the vehicle according to an example of a preferred embodiment of the present invention; and

FIG. 10 is a diagram illustrating an example of display of warning symbols on the vehicle-mounted navigation apparatus or the vehicle according to an example of a preferred embodiment of the present invention.

### DETAILED DESCRIPTION OF THE INVENTION

Hereinafter, preferred embodiments of the present invention will be described with reference to the drawings.

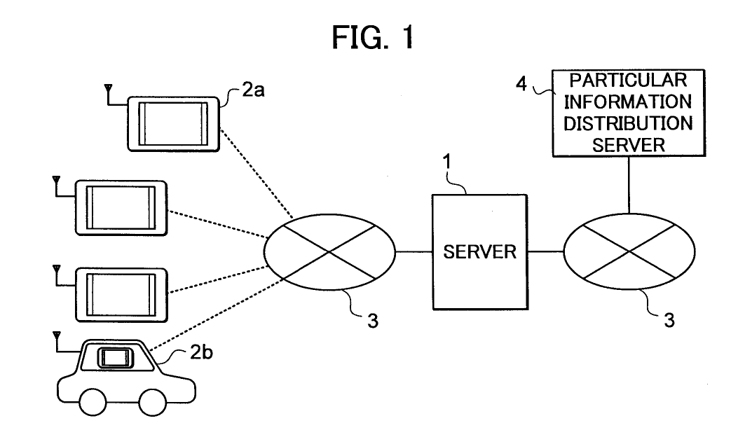

FIG. 1 is a block diagram illustrating a schematic structure of a particular information distribution system which is one embodiment of the present invention. As shown in FIG. 1, the particular information distribution system of this embodiment may include vehicle-mounted navigation apparatuses 2a, a vehicle 2b, a server 1, and a particular information distribution server 4 which are connected each other via a communication link network 3. The server 1 may receive particular information from the particular information distribution server 4 via the communication link network 3. The system may receive positional information or route information from the vehicle-mounted navigation apparatus 2a or the vehicle 2b, process the particular information in order to send information specific to the area in which the present position or the route of the vehicle is present, and distribute it to the vehicle-mounted navigation apparatus 2a or the vehicle 2b.

As used herein, the term “particular information” may refer to information regarding meteorology, including information regarding various weather advisories, warnings, or the like, such as weather forecasts or the AMeDAS data or the like, provided by the Japan Weather Association. It may include, for example, the AMeDAS data, including wind velocities, rainfall, snowfall, typhoon details, the AMeDAS forecast data, ultraviolet ray intensity information, temperature information, pollen dispersal amount information, heat stroke warning information, information on volcanoes, information on tsunamis or earthquakes, and the types of information are not limited to those described above. Other than the meteorological information, the server 1 may receive a plurality of other types of information, and send it to the vehicle-mounted navigation apparatus 2a or the vehicle 2b together with the particular information. For example, such information may include traffic information, such as information on congestion or accidents, or information on the present position of the vehicle or the destination area of the vehicle. Such information is processed similarly to the particular information.

The particular information distribution server 4 may be a server which distributes principally information regarding weather or meteorology, including meteorological information, such as weather forecast or the AMeDAS data, information on earthquakes, tsunamis, various weather advisories, warnings, or the like. The number of the particular information distribution servers 4 is not limited to one, and multiple particular information distribution servers 4 may be present.

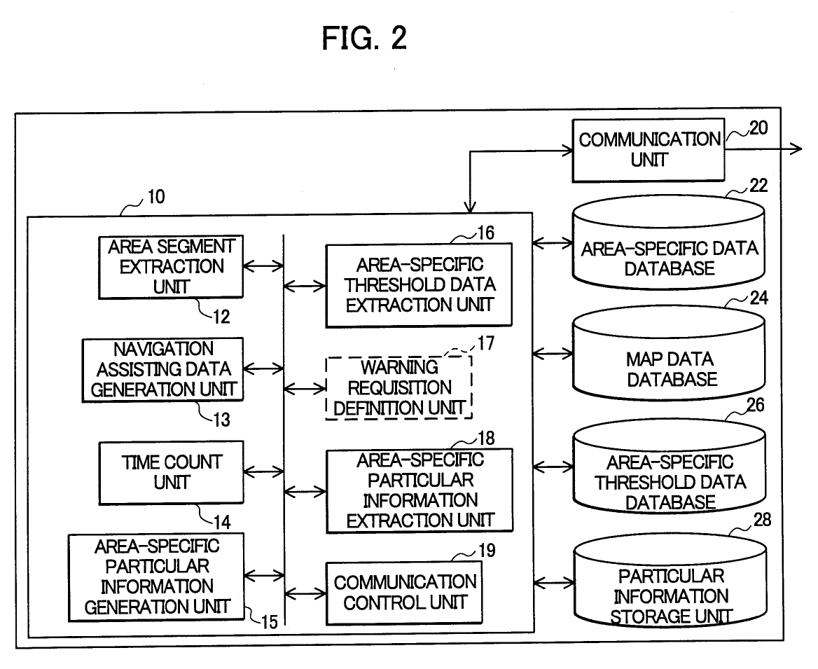

Upon receiving distribution of the particular information or other types of information from the particular information distribution server 4, the server 1 may classify the received particular information for each area segment in order to distribute the received particular information to the vehicle-mounted navigation apparatus 2a or the vehicle 2b, and may edit the data and send it to the vehicle-mounted navigation apparatus 2a or the vehicle 2b. The server 1 may include a control unit 10, a communication unit 20, an area-specific data database 22, a map data database 24, an area-specific threshold data database 26, and a particular information storage unit 28, as shown in FIG. 2. In addition to obtaining data through reception of distributed data from the particular information distribution server 4, the server 1 may include a reader of recording media, such as CD-ROMs or DVD-ROMs and obtain the particular information or other information through reading from a recording medium.

The area-specific data database 22 may be a database that stores area-specific particular information that associates particular information stored in the particular information storage unit 28 with a certain area segment and is classified according to each area.

The map data database 24 may be a database that stores map data as well as data of area segments that are obtained by dividing an area into certain segments. The area-specific threshold data database 26 may be a database that stores threshold data for each area segment. The particular information storage unit 28 may be a database that stores the particular information received from the particular information distribution server 4. The particular information storage unit 28 may not only store the up-to-date particular information but also accumulate particular information in the past in the statistic manner. It is to be noted that each of these databases or storage units may be composed of a computer readable and writable recording medium, such as non-volatile memories, e.g., a hard disk device, a magneto-optical disk device, a flash memory, or volatile memories e.g., a random access memory (RAM), or a combination thereof. Furthermore, these databases may not be necessarily located inside the server 1, and the databases may be provided outside the server or a dedicated device may be provided.

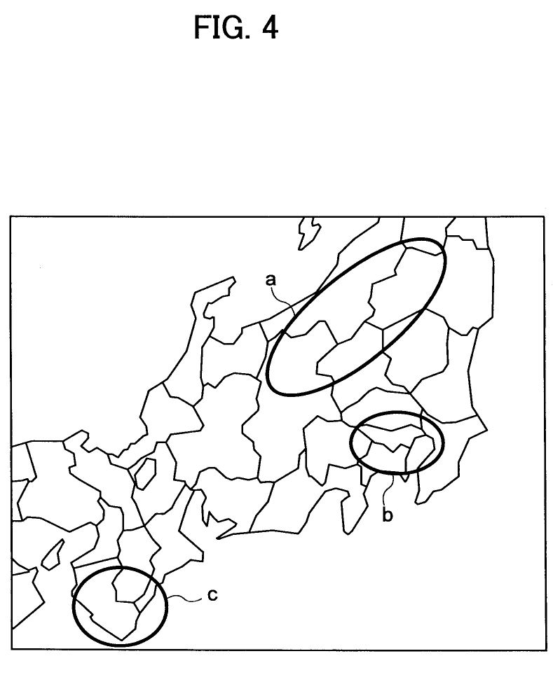

As used herein the term “area-specific threshold data” refers to data regarding thresholds of rainfall, snowfall, wind velocities, or the like, that are defined for each of certain area segments for issuing warnings to the vehicle-mounted navigation apparatus 2a or the vehicle 2b. For example, as shown in FIG. 4, since a small amount of snow does not probably affect the public transportation and traffic systems in area “a”, the threshold of snowfall for displaying a warning is set lower than those in other areas. On the contrary, even a small amount of snow generally affects the public transportation and traffic systems in area “b”, as in the metropolitan area. Therefore, the necessity of warnings is determined using a threshold that is lower than those of other areas. Similarly in area “c” having a high annual rainfall, the threshold of rainfall is set high. In this manner, thresholds that are set for the same categories, such as snowfall or rainfall, are different from area to area. These thresholds may be set by using predetermined thresholds or defined by statistically processing particular information stored in the area-specific data database 22.

The communication unit 20 may communicate with the particular information distribution server 4, the vehicle-mounted navigation apparatus 2a, and the vehicle 2b via the communication link network 3. The communication unit 20 may include an interface that is capable of connecting to a network, for example, a local area network (LAN).

The control unit 10 may be a computer system including a central processing unit (CPU), and may control all of operations of the server 1, as well as performing communication with the particular information server, the vehicle-mounted navigation apparatus 2a, or the vehicle 2b via the communication unit 20. The control unit 10 may also perform operations according to various types of information it receives, and send data in response to a request from the vehicle-mounted navigation apparatus 2a or the vehicle 2b. The control unit 10 may include an area segment extraction unit 12, a navigation assisting data generation unit 13, a time count unit 14 that counts time, an area-specific particular information generation unit 15, an area-specific threshold data extraction unit 16, a warning necessity definition unit 17, an area-specific particular information extraction unit 18, and a communication control unit 19, which are all connected via a bus. It is to be noted that the warning necessity definition unit 17 may be omitted, and when the vehicle-mounted navigation apparatus 2a or the vehicle 2b has a mechanism that is equivalent to the warning necessity definition unit 17, it may be omitted from the server 1.

The area-specific particular information generation unit 15 may read particular information stored in the particular information storage unit 28 and data of the area segments stored in the map data database 24, and generate area-specific particular information by classifying the particular information for each area segment. The area-specific particular information generation unit 15 may then store the area-specific particular information that it generates, in the area-specific data database.

The area segment extraction unit 12 in the control unit 10 may determine an area segment corresponding to the present position based on the positional information and/or the route information that are received from the vehicle-mounted navigation apparatus 2a or the vehicle 2b. For area segments, the standardized regional mesh may be used which is obtained by dividing the area with lines of longitude and latitude, for example. Furthermore, as a segment unit, any mesh may be selected, and the examples may include a first order grid mesh in which the territory of Japan is divided per 1° longitude and 40° latitude, a so-called second order grid mesh in which one grid of the first order grid mesh is divided equally into eight in the direction of longitude and latitude, and a third order grid mesh (i.e., so-called 1 Km mesh) in which one grid of the second order grid mesh is further divided equally into ten in the directions of longitude and latitude. Furthermore, area segments that are defined as desired may be used.

The area-specific threshold data extraction unit 16 in the control unit 10 may extract certain area-specific threshold data corresponding to the area segment determined by the area segment extraction unit 12 from the area-specific threshold data database 26. The area-specific threshold data extraction unit 16 may then send the extracted area-specific threshold data to the warning necessity definition unit 17.

The area-specific particular information extraction unit 18 may extract certain area-specific particular information corresponding to the area segment determined by the area segment extraction unit 12 from the area-specific data database 22. The area-specific threshold data extraction unit 16 may then send the extracted area-specific particular information to the warning necessity definition unit 17. It is to be noted that the area-specific threshold data and the area-specific particular information may be sent to the navigation assisting data generation unit 13 when the server 1 does not include the warning necessity definition unit 17.

The warning necessity definition unit 17 in the control unit 10 may determine whether or not a warning is necessary to the vehicle-mounted navigation apparatus 2a or the vehicle 2b based on the area-specific threshold data extracted by the area-specific threshold data extraction unit 16 and the area-specific particular information extracted by the area-specific particular information extraction unit 18, and generate warning necessity information. The warning necessity information may include an indication as of whether or not a warning is necessary in the area segment concerned and the type of warning (weather warning or advisories, weather conditions, or other information). More specifically, for example, when the area-specific particular information exceeds the threshold of the area-specific threshold data of the corresponding area segment, it is determined that a warning is necessary. On the contrary, when the area-specific particular information does not exceed the threshold of the area-specific threshold data of the corresponding area segment, it is determined that no warning is necessary. It is to be noted that the warning necessity definition unit 17 may be omitted.

The navigation assisting data generation unit 13 generates navigation assisting data that is to be sent to the vehicle-mounted navigation apparatus 2a or the vehicle 2b. More specifically, for example, when the server 1 includes the warning necessity definition unit 17, the navigation assisting data generation unit 13 may read the warning necessity information generated by the warning necessity definition unit 17 from the warning necessity definition unit 17 as well as the corresponding area-specific particular information, and generate the navigation assisting data. The communication control unit 19 may then send via the communication unit 20 the navigation assisting data to the vehicle-mounted navigation apparatus 2a or the vehicle 2b from which the distribution request has been received. On the contrary, when the server 1 does not include the warning necessity definition unit 17, the navigation assisting data generation unit 13 may generate the navigation assisting data based on the corresponding area-specific information and the area-specific threshold data that are read by the area-specific particular information extraction unit 18 and the area-specific threshold data extraction unit 16, respectively. The communication control unit 19 may then send via the communication unit 20 the navigation assisting data to the vehicle-mounted navigation apparatus 2a or the vehicle 2b from which the distribution request has been received.

The communication control unit 19 may receive information from the particular information distribution server 4 and the vehicle-mounted navigation apparatus 2a, or the vehicle 2b via the communication unit 20, and may pass the received information to appropriate databases and components of the control unit 10. The communication control unit 18 may also control transmission via the communication unit 20 of the data processed by various components of the control unit 10.

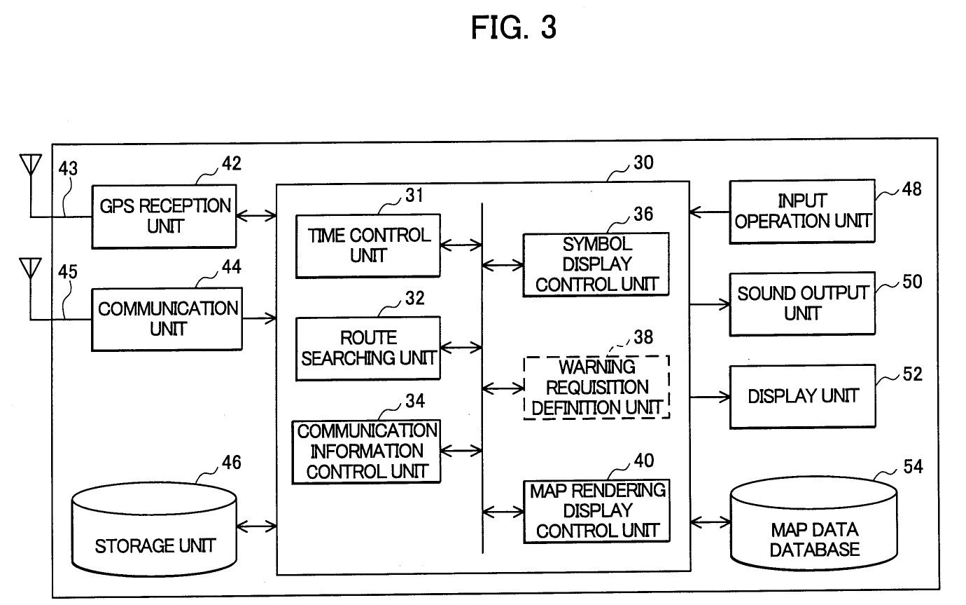

The vehicle-mounted navigation apparatus 2a or the vehicle 2b may include at least a Global Positioning System (GPS) reception unit 42, a GPS antenna 43, a communication unit 44, a communication antenna 45, a control unit 30, an input operation unit 48, a sound output unit 50, a display unit 52, and a map data database 54, as shown in FIG. 3.

The communication unit 44 in the vehicle-mounted navigation apparatus 2a or the vehicle 2b may be a communication unit that communicates to the server 1 through the communication link network 3 according to commands from the control unit 30, and the communication may wireless or wired. The communication unit 44 may communicate with the server 1 via the communication link network 3. The communication unit 44 may include an interface that is capable of connecting to a network, for example, a local area network (LAN). A mobile terminal may be connected and the communication unit 44 may be is constructed from the mobile terminal.

The control unit 30 may be a computer system including a central processing unit (CPU), and may include a time control unit 31 that controls the operations of the vehicle-mounted navigation apparatus 2a or the vehicle 2b and counts time, a route searching unit 32, a communication information control unit 34, a symbol display control unit 36, a warning necessity definition unit 38, and a map rendering display control unit 40. The control unit 30 may output meteorological information and a warning on a display unit 52 and/or to a sound output unit 50 if necessary based on information on the present position of the vehicle received by the GPS reception unit 42 and the navigation assisting data received from the server 1. It is to be noted that the warning necessity definition unit 38 may be omitted when the server 1 has a mechanism that determines whether or not a warning is necessary.

The route searching unit 32 may read from the map data database 54 the map data corresponding to a destination that is input by the user using the input operation unit 48, and may determine the route to be navigated. Upon receiving an input from the user, the map data may be displayed on the display unit 52 by means of the map rendering display control unit 40 to assist the user to select the route.

The communication information control unit 34 may receive information from the server 1 or send a distribution request via the communication unit 44. The communication information control unit 34 may also pass the information that it has received to various components of the control unit 30. The communication information control unit 34 may also control transmission via the communication unit 44 of the data or the like processed by various components in the control unit 30.

As for the symbol display control unit 36, when no command is sent the warning necessity definition unit 38 or the warning necessity definition unit is omitted, the symbol display control unit 36 may read from a storage unit 46 symbol data, messages or marks, to be displayed on the display unit 52, based on the warning necessity information contained in the navigation assisting data sent from the server, perform processes for displaying the symbols, and send a command to the display unit 52. Furthermore, when the storage unit 46 contains sound data, the corresponding sound data may be read from the storage unit 46 and may-be output from the sound output unit 50 as a sound in addition to the display of the symbol data. Alternatively, only the sound may be output. The symbol display control unit 36 and/or the sound output unit 50 described above may function as warning-related output control devices.

The warning necessity definition unit 38 may determine whether or not a warning is necessary in the present position of the vehicle or en route to the destination that is determined based on the positional information received by the GPS reception unit 42, based on the area-specific threshold data contained in the navigation assisting data received from the server 1 and area-specific segment information stored in the map data database 54. More specifically, for example, the warning necessity definition unit 38 may compare the area-specific particular information with the area-specific threshold data in the navigation assisting data, and make the decision by determining whether or not the area-specific particular information exceeds the threshold of the area-specific threshold data of the corresponding area segment. When the area-specific particular information exceeds the threshold of the area-specific threshold data of the corresponding area segment, it is determined that a warning is necessary and a command is sent to the symbol display control unit 36 for displaying a warning symbol. On the contrary, when the area-specific particular information does not exceed the threshold of the area-specific threshold data of the corresponding area segment, it is determined that no warning is necessary and no command is sent. It is to be noted that the warning necessity definition unit 38 may be omitted and the vehicle-mounted navigation apparatus 2a or the vehicle 2b may not include it.

The map rendering display control unit 40 may read map data from the map data database 54, and display the map on the display unit 52 during route navigation, upon determination of a route, or upon receiving a request that is entered through the input operation unit 48.

Furthermore, the control unit 30 may be connected to the storage unit 46 and the map data database 54. The storage unit 46 may store the navigation assisting data received from the server 1, temporary data used by the control unit 30, route information, various settings entered via inputs from the input operation unit 48 or the like, and symbol data that is to be displayed on the display unit 52 and sound data that is to be output from the sound output unit 50 when issuing a warning. The map data database 54 may store map data used for route navigations or the like and area segment data in which the area segments are obtained by dividing an area in a predetermined segment. The control unit 30 may obtain various types of data by reading data stored in the storage unit 46 and the map data database 54.

The control unit 30 may also be connected to the input operation unit 48, the sound output unit 50, and/or the display unit 52. The input operation unit 48 may include a keypad, buttons, a pointing device, or the like through which the user can operate the vehicle-mounted navigation apparatus 2a or the vehicle 2b. For providing a route navigation, not only with the display on the display unit 52, the sound output unit 50 may output the voice guidance of the route or warning symbols or the like for assisting the display. The display unit 52 may include a device for displaying text or a map, such as a liquid crystal display; it may be integrated into the main body of the vehicle-mounted navigation apparatus 2a or the vehicle 2b, or a separate display device may be connected to provide the display unit 52.

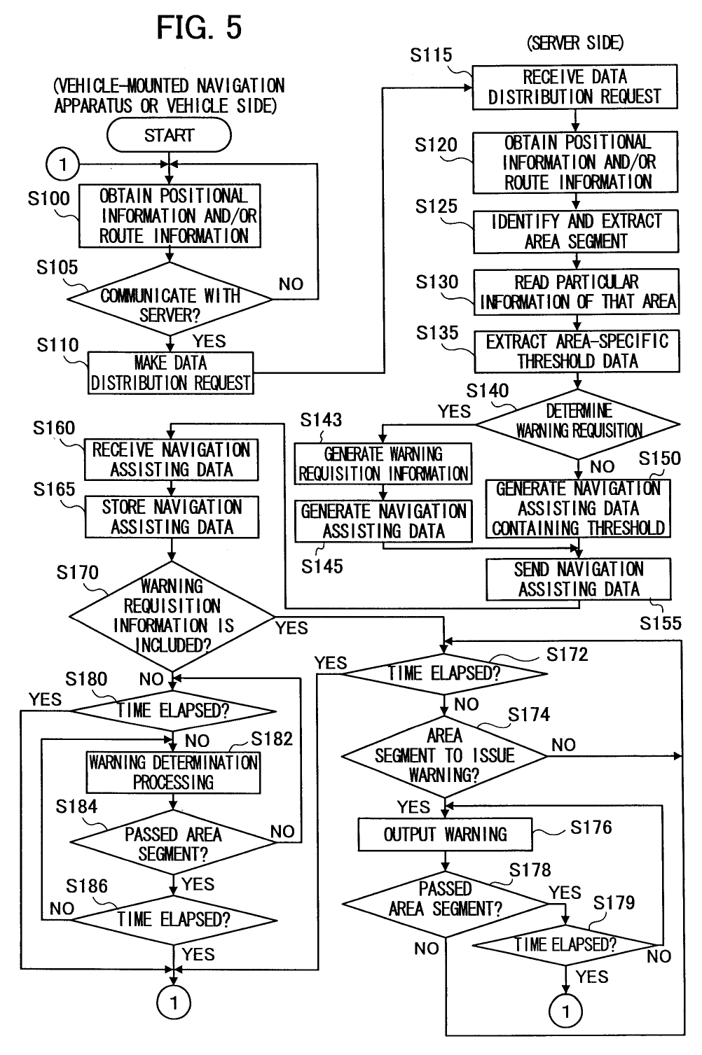

Next, operations and process procedures of the vehicle-mounted navigation apparatus 2a or the vehicle 2b and the server 1 which are embodiments of the present invention will be explained with reference to the drawings. FIG. 5 is a flowchart showing operations and process procedures of the vehicle-mounted navigation apparatus 2a or the vehicle 2b and a server which are one embodiment of the present invention.

First, the control unit 30 in the vehicle-mounted navigation apparatus 2a or the vehicle 2b may obtain the present position of the vehicle from the GPS reception unit 42 of the vehicle. Furthermore, when the user has set a destination, the control unit 30 in the vehicle-mounted navigation apparatus 2a or the vehicle 2b may obtain route information to the destination that has been set using the route searching unit 32 (step S100).

Next, the control unit 30 may determine whether or not a connection to the server 1 is to be established (step S105). This determination may be made by connecting to the server 1 when the route information is obtained from the route searching unit 32 in step S100, or by making a connection request to the server 1 by a time control unit 31 at a predetermined time interval. This predetermined time interval may be a preset time, or it may be set by the user via the input operation unit 48. When the control unit 30 determines that no connection to the server 1 is to be established in this determination, the flow returns to step S100. Otherwise, when the control unit 30 determines that a connection to the server 1 is to be established, a distribution request is made to the server 1 (step S110).

This distribution request to the server 1 (step S110) is made by sending a signal indicating the distribution request together with the positional information and the route information of the vehicle-mounted navigation apparatus 2a or the vehicle 2b. It is to be noted that either one of the positional information or the route information may be sent to the server 1. After sending distribution request, the flow moves to the server 1 and the control unit 10 in the server 1 may accept the distribution request from the vehicle-mounted navigation apparatus 2a or the vehicle 2b via the communication unit 44 (step S115). The control unit 10 in the server 1 may then obtain the positional information and the route information of the vehicle-mounted navigation apparatus 2a or the vehicle 2b that are sent together with the distribution request (step S120). Alternatively, in order to accept the positional information and/or the route information of the vehicle-mounted navigation apparatus 2a or the vehicle 2b, the control unit 10 in the server 1 may first send a signal requesting the vehicle-mounted navigation apparatus 2a or the vehicle 2b from which the distribution request has been received to send the positional information and/or the route information of the vehicle-mounted navigation apparatus 2a or the vehicle 2b. The control unit of the vehicle-mounted navigation may then receive the request from the server 1, and send the positional information and/or the route information of the vehicle-mounted navigation apparatus 2a or the vehicle 2b, which is received by the communication unit 20 of the server 1.

After the control unit 10 in the server 1 obtaining the positional information and/or the route information of the vehicle-mounted navigation apparatus 2a or the vehicle 2b that made the distribution request in step S120, the area segment extraction unit 12 may first extract an area segment corresponding to the received positional information and/or route from the map data database 54 (step S125). When the area segment is extracted, the area-specific particular information extraction unit 18 may extract particular information of that area segment from the area-specific data database 22 (step S130). The area-specific threshold data extraction unit 16 may extract area-specific threshold data that is associated with that area segment (step S135). It is to be noted that, when the route information is received in addition to the positional information, the similar steps are performed for each area segment on the route, not only for the positional information.

The control unit 10 may then determine whether or not warning necessity should be determined. This determination may be made based on the presence or absence of the warning necessity definition unit 17 in the server 1. When the warning necessity definition unit 17 is present, the server 1 defines the warning necessity and the flow moves to step S143. Otherwise, when the warning necessity definition unit 17 is absent, no warning necessity is defined and the flow moves to step S150.

In step S143, the warning necessity definition unit 17 may determine whether or not a warning is necessary based on the extracted area-specific particular information and area-specific threshold data, and generate warning necessity information. More specifically, a determination is made as to whether or not the area-specific particular information extracted in step S130 exceeds the threshold of the area-specific threshold data, and when the area-specific particular information exceeds the threshold, it is determined that a warning is necessary. When the area-specific particular information does not exceed the threshold, it is determined that no warning is necessary. It is to be noted that determination is made as to whether or not a warning is necessary for each segment on the route when the control unit 10 has obtained route information. Then warning necessity information is generated for each area segment.

The navigation assisting data generation unit 13 may then generate navigation assisting data containing the warning necessity information and the area-specific particular information (step S145). When warning necessity is not defined in step S140, the navigation assisting data generation unit 13 may generate navigation assisting data containing the area-specific particular information as well as the area-specific threshold data (step S150).

Once the navigation assisting data generation unit 13 generates the navigation assisting data in step S145 or step S150, the control unit 10 may send via the communication unit 20 the navigation assisting data to the vehicle-mounted navigation apparatus 2a or the vehicle 2b that has made the distribution request (step S155). The flow moves to the vehicle-mounted navigation apparatus 2a or the vehicle 2b after this step.

The vehicle-mounted navigation apparatus 2a or the vehicle 2b may receive the navigation assisting data from the server 1 (step S160), and the time control unit 31 in the vehicle-mounted navigation apparatus 2a or the vehicle 2b may start to count time. The control unit 30 may store the received navigation assisting data in the storage unit 46 (step S165). The control unit 30 may then determine whether or not warning necessity information is contained in the received navigation assisting data (step S170). When no warning necessity information is contained, the flow moves to step S180, whereas the flow moves to step S172 when it is determined that warning necessity information is contained.

In step S172, it is determined whether or nor a predetermined time interval for requesting distribution has elapsed. This determination may be made by the time control unit 31 in the control unit 30 in the vehicle-mounted navigation apparatus 2a or the vehicle 2b by counting time elapsed since the navigation assisting data was received, and when the predetermined time has elapsed, the flow returns to step S100. On the contrary, when the predetermined time has not yet elapsed, the flow returns to step S174. This predetermined time interval may be fixed, or may be set by the user of the vehicle-mounted navigation apparatus 2a or the vehicle 2b. By counting the time elapsed since the navigation assisting data was received and determining whether or not the predetermined time has passed, the navigation assisting data is prevented from being obsolete. That is, in some cases, it may take some time to issue a warning after the navigation assisting data is received. An example is a case where the vehicle stops for a long-time in an area segment in which no warning is necessary. When a long time has elapsed before a warning is issued, meteorological information or traffic information or the like may change every moment. It is possible to address this situation by requesting distribution to the server 1 when the predetermined time has passed. This may be performed in steps S179, S180, and S186.

In step S174, the control unit 10 may determine whether or not a warning is necessary in the area segment in which the present position of the vehicle-mounted navigation apparatus 2a or the vehicle 2b is located. This determination may be made by the control unit 30 by reading the warning necessity information contained in the received navigation assisting data. That is, when the warning necessity information indicates that a warning is necessary in that area segment, the flow moves to step S176. When it is determined that no warning is necessary, the flow returns to step S172. The symbol display control unit 36 in the control unit 30 may then read corresponding symbol data and/or sound data from the storage unit 46, and display the symbol on the display unit 52 and/or output the sound from the sound output unit (step S176).

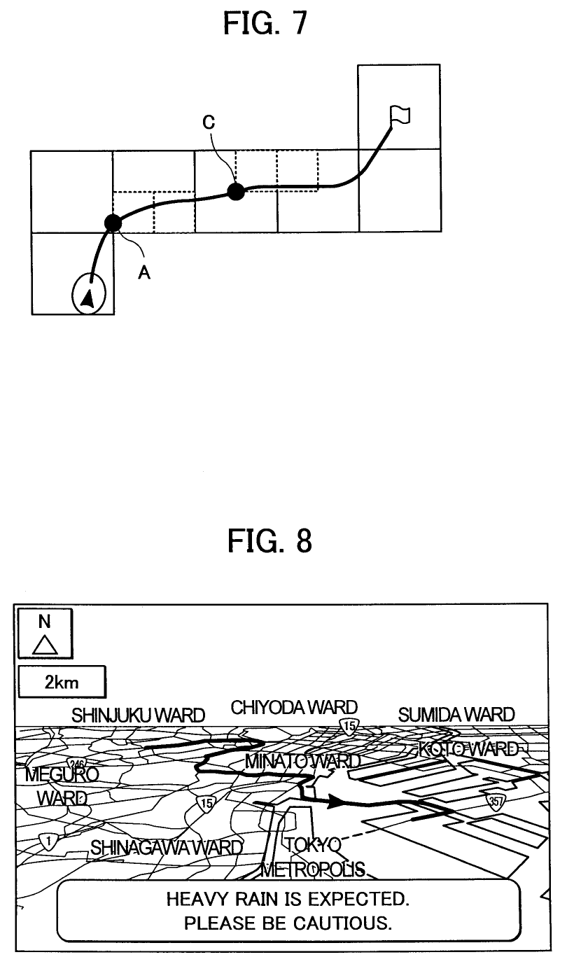

The control unit 30 may send a command to the symbol display control unit 36 for instructing it to display a warning symbol for warning. For example, as shown in FIG. 7, a warning message may be displayed as a symbol superimposing the map data displayed on the display unit 52 by the map rendering display control unit 40. Furthermore, the warning is not limited to messages; a moving image showing falling rain may be displayed, for example, or a symbol indicating a lightening or heavy snow or the like may be displayed to the forward direction. Furthermore, in addition to the display on the display unit 52, a warning by means of sound may be output from the sound output unit 50. In this case, the symbol display control unit 36 may read sound data from the storage unit 46 for outputting it from the sound output unit 50. For example, meteorological information, such as “A landslide may occur on your route ahead due to heavy rain. Please be cautious.” may be provided. Alternatively, weather warnings and advisories, such as “A snowfall of 2 cm to 5 cm is predicted on your route ahead” may be provided. In addition, a narration of the AMeDAS data or other types of area information may be output. It is to be noted that the warning symbol is not limited to the above examples.

The control unit 30 may then determine whether or not the present position of the vehicle received from the GPS reception unit 42 has crossed the border of the area segment (step S178). The control unit 30 may then determine whether or not the predetermined time interval for requesting distribution has elapsed when the vehicle crossed the border of the area segment (step S179). If the vehicle does not go out of the area segment, the flow moves to step S172. The determination made in step S179 is the similar to that made in step S172 that is described previously. When the predetermined time has elapsed, the flow returns to step S100. On the contrary, when the predetermined time has not yet elapsed, the flow returns to step S176.

It is determined in step S170 that the navigation assisting data contains no warning necessity information, the flow moves to step S180. The determination made in step S180 is the similar to that made in step S172 that is described previously. When the predetermined time has elapsed, the flow returns to step S100. On the contrary, when the predetermined time has not yet elapsed, the flow returns to step S182.

In step S182, the warning determination processing is performed. This processing will be described later. After this processing is completed, the flow moves to step S184.

The control unit 30 may then determine whether or not the present position of the vehicle received from the GPS reception unit 42 has crossed the border of the area segment (step S184). The control unit 30 may then determine whether or not the predetermined time interval for requesting distribution has elapsed when the vehicle does not cross the border of the area segment (step S186). If the vehicle does not go out of the area segment, the flow moves to step S180. The determination made in step S186 is the similar to that made in step S172 that is described previously. When the predetermined time has elapsed, the flow returns to step S100. On the contrary, when the predetermined time has not yet elapsed, the flow returns to step S182.

Warning Determination Processing

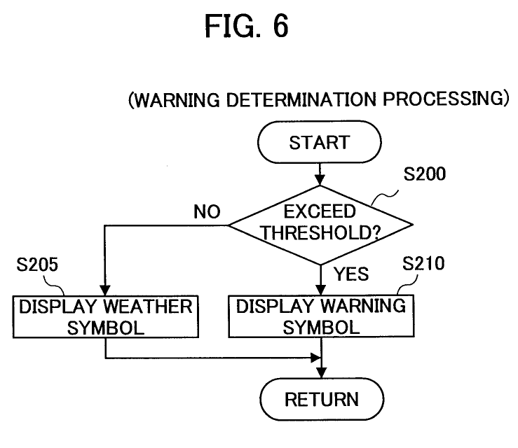

The flow of processes of the warning determination processing in step S182 will be described. FIG. 6 is a flowchart showing the flow of processes of the warning determination processing.

First, the warning necessity definition unit 38 may read the area-specific particular information and the area-specific threshold data from the storage unit 46. The warning necessity definition unit 38 may then determine whether or not the area-specific particular information corresponding to the area segment in which the present position detected by the GPS is located exceeds the threshold of that area segment of the area-specific threshold data (step S200). If it is determined that the area-specific particular information does not exceed the threshold, the control unit 30 may send a command to the symbol display control unit 36 for instructing it to show a weather symbol indicating the current weather on the display unit 52 (step S205). Note that no weather symbols or the like may be displayed. Furthermore, weather symbols may be displayed superimposing the map data displayed on the display unit 52 by the map rendering display control unit 40. The symbols displayed are not limited to weather symbols.

When the warning necessity definition unit 38 determines that a warning is necessary in step S200, the control unit 30 may send a command to the symbol display control unit 36 for instructing it to display a warning symbol for warning. For example, as shown in FIG. 7, a warning message may be displayed as a symbol superimposing the map data displayed on the display unit 52 by the map rendering display control unit 40 (step S210). Furthermore, the warning is not limited to messages; a moving image showing falling rain may be displayed, for example, or a symbol indicating a lightening or heavy snow or the like may be displayed to the forward direction. Furthermore, in addition to the display on the display unit 52, a warning by means of sound may be output from the sound output unit 50. In this case, the symbol display control unit 36 may read sound data from the storage unit 46 for outputting it from the sound output unit 50. For example, meteorological information, such as “A landslide may occur on your route ahead due to heavy rain. Please be cautious.” may be provided. Alternatively, weather warnings and advisories, such as “A snowfall of 2 cm to 5 cm is predicted on your route ahead” may be provided. In addition, a narration of the AMeDAS data or other types of area information may be output. It is to be noted that the warning symbol is not limited to the above examples. After this processing is completed, the execution of this subroutine ends and the flow moves to step S182.

As described above, the server 1 may obtain the positional information and optionally the route information from the vehicle-mounted navigation apparatus 2a or the vehicle 2b, and select meteorological information to be sent to the vehicle-mounted navigation apparatus 2a or the vehicle 2b and determine whether or not a warning is necessary for the area segment including the location indicated by the positional information thereof or each area segment the vehicle travels on the route. The vehicle-mounted navigation apparatus 2a or the vehicle 2b may receive the information from the server 1, and determine whether or not a warning is necessary in the area segment of the location of the vehicle. For example, as shown in FIG. 6, the entire national territory of Japan is divided into several area segments beforehand. When the location of the vehicle “a” enters Area segment A, the area-specific particular information and the area-specific threshold data are read and whether or not a warning is necessary is determined.

Since the land is divided into the area segments and data corresponding to each area segment is selected by the server 1 for sending it to the vehicle-mounted navigation apparatus 2a or the vehicle 2b, the size of data to be transmitted can be reduced. This allows reduction in the time required for the data transmission and communication fees compared with cases when the nationwide data is sent. Furthermore, since a threshold is defined for each area segment and this threshold is sent, communication while traveling the area segment is prevented from frequently occurring. In addition, since no data of warning symbols or the like is transmitted, it becomes possible to reduce the data size, which enables saving of communication time and communication fees required for the communication.

While embodiments of the invention have been described, these are illustrated merely as specific examples and do not specifically limit the invention. Furthermore, the effects achieved by the embodiments of the present invention described above are merely the most preferred effects provided by the present invention, and the effects of the present invention are not limited to those described with regard to the embodiments of the present invention.

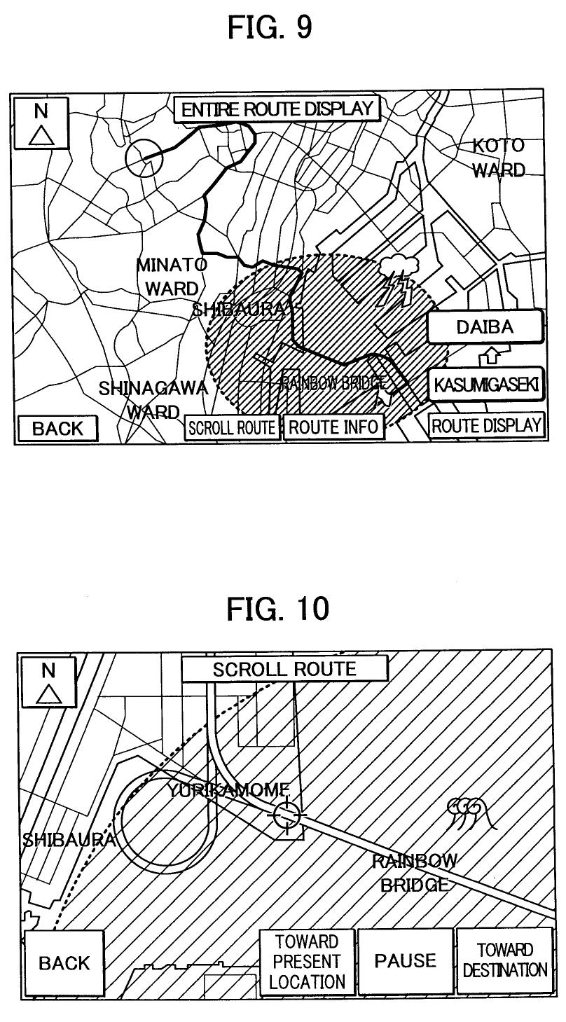

For example, as a variation of the present invention, after the vehicle-mounted navigation apparatus 2a or the vehicle 2b receives the navigation assisting data from the server 1 (step S160), the entire route may be displayed on the display unit. In this case, when there is an area in which a warning is necessary on the route, the area having the warning and the type of the warning may be displayed on the display unit 52 (FIG. 9). Furthermore, when the route to the destination is displayed in a small scale and the map is scrolled, if there is an area in which a warning is necessary on the route, the warning may be shown on the display.

Furthermore, the server 1 may include an input and output device and it may take necessary actions in the case of a sudden disaster or the like by changing the area-specific threshold data stored in the area-specific threshold data database 26 in response to an input received via the input and output device.

Furthermore, after the server 1 sends the navigation assisting data to the vehicle-mounted navigation apparatus 2a or the vehicle 2b, the time count unit 14 in the server 1 may count a predetermined time and the server 1 may send latest navigation assisting data after the predetermined time elapses. In this case, navigation assisting data may be generated based on the latest positional information and/or route information that has been received. Furthermore, the server 1 may send a signal requesting the vehicle-mounted navigation apparatus 2a or the vehicle 2b to send the positional information and/or the route information after a predetermined time elapses, and in response, the vehicle-mounted navigation apparatus 2a or the vehicle 2b may send the positional information and/or the route information to the server 1 which may generate navigation assisting data based on the information.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A server that is capable of communicating with a vehicle, the server comprising:
a particular information storage device that stores particular information;
an area-specific particular information storage device that stores area-specific particular information, the area-specific particular information associating the particular information with an area segment;
a vehicle information reception device that receives at least one of positional information and route information of the vehicle;
an area-specific threshold data extraction device that extracts area-specific threshold data of a corresponding area segment from the area-specific particular information based on the information received by the vehicle information reception device;
a warning necessity determination device that determines whether or not a warning is necessary based on the area-specific threshold data and the particular information;
a navigation assisting data generation device that generates navigation assisting data containing the warning necessity information, determined by the warning necessity determination device, and the area-specific particular information; and
a transmission device that sends the navigation assisting data to the vehicle.

2. A server that is capable of communicating with a vehicle, the server comprising:
a particular information storage device that stores particular information;
an area-specific particular information storage device that stores area-specific particular information, the area-specific particular information associating the particular information with an area segment;
a vehicle information reception device that receives at least one of positional information and route information of the vehicle;
an area-specific threshold data extraction device that extracts area-specific threshold data of a corresponding area segment from the area-specific particular information based on the information received by the vehicle information reception device;
a navigation assisting data generation device that generates navigation assisting data containing the area-specific particular information and the area-specific threshold data; and
a transmission device that sends the navigation assisting data to the vehicle.

3. A server according to claim 1, wherein the particular information is meteorological information.

4. A server according to claim 1, wherein
a navigation information reception device of the server, in response to the vehicle connecting to the server via a communication device and making a distribution request for the navigation assisting data to the server, receives the distribution request from the vehicle, and
sends, by the transmission device, the navigation assisting data generated by the navigation assisting data generation device.

5. A vehicle-mounted navigation apparatus for searching for a route corresponding to a destination of a vehicle, displaying map data on a display device, and providing route navigation, the apparatus comprising:
a position determination device that can determine a present position of the vehicle;
a communication device that communicates with the server;
a server information storage device that stores navigation assisting data containing area-specific threshold data for each area segment for determining whether or not a warning is necessary and area-specific particular information for the each area segment, that are sent by the server and received by the communication device;
a warning necessity determination device that determines whether or not the warning is required based on the area-specific threshold data and the area-specific particular information that are stored in the server information storage device; and
a warning-related output control device that controls at least one of a display of a symbol and an output of sound related to the warning, based on the determination made by the warning necessity determination device.

6. A vehicle-mounted navigation apparatus for searching for a route corresponding to a destination of a vehicle, displaying map data on a display device, and providing route navigation, the apparatus comprising:
a position determination device that can determine a present position of the vehicle;
a communication device that communicates with the server;
a server information storage device that stores navigation assisting data containing area-specific threshold data for each area segment for determining whether or not a warning is necessary and area-specific particular information for the each area segment, that are sent by the server and received by the communication device; and
a warning-related output control device that controls at least one of a display of a symbol and an output of sound related to the warning, based on warning necessity information that is stored in the server information storage device.

7. A vehicle-mounted navigation apparatus according to claim 5, wherein the area-specific particular information is meteorological information for each area segment.

8. A vehicle for searching for a route corresponding to a destination of the vehicle, displaying map data on a display device, and providing route navigation, the vehicle comprising:
a position determination device that can determine a present position of the vehicle;
a communication device that communicates with the server;
a server information storage device that stores navigation assisting data containing area-specific threshold data for each area segment for determining whether or not a warning is necessary and area-specific particular information for the each area segment, that are sent by the server and received by the communication device;
a warning necessity determination device that determines whether or not the warning is required based on the area-specific threshold data and the area-specific particular information that are stored in the server information storage device; and
a warning-related output control device that controls at least one of a display of a symbol and an output of sound related to the warning, based on the determination made by the warning necessity determination device.

9. A vehicle for searching for a route corresponding to a destination of the vehicle, displaying map data on a display device, and providing route navigation, the vehicle comprising:
a position determination device that can determine a present position of the vehicle;
a communication device that communicates with the server;
a server information storage device that stores navigation assisting data containing warning necessity information by which the server determines whether or not a warning is necessary, and area-specific particular information for each area segment, that are sent by the server and received by the communication device; and
a warning-related output control device that controls at least one of a symbol display for displaying a symbol and sound output related to the warning, based on the warning necessity information that is stored in the server information storage device.

10. A vehicle according to claim 8, wherein the area-specific particular information is meteorological information for each area segment.

11. A particular information distribution system comprising a server and a vehicle, the server and the vehicle being capable of communicating each other,
the server comprising:
a particular information storage device that stores particular information;
an area-specific particular information storage device that stores area-specific particular information, the area-specific particular information associating the particular information with an area segment;
a vehicle information reception device that receives at least one of positional information and route information of the vehicle;
an area-specific threshold data extraction device that extracts area-specific threshold data of a corresponding area segment from the area-specific particular information, based on the information corresponding to the reception by the vehicle information reception device;
a warning necessity determination device that determines whether or not a warning is necessary based on the area-specific threshold data and the particular information;
a navigation assisting data generation device that generates navigation assisting data containing the warning necessity information determined by the warning necessity determination device and the area-specific particular information; and
a transmission device that sends the navigation assisting data to the vehicle, and
the vehicle comprising:
a position determination device that can determine a present position of the vehicle;
a communication device that communicates with the server;
a server information storage device that stores the navigation assisting data received from the server; and
a warning-related output control device that controls at least one of a display of a symbol and an output of sound related to the warning, based on warning necessity information that is stored in the server information storage device.

12. A particular information distribution system comprising a server and a vehicle, the server and the vehicle being capable of communicating each other,
the server comprising:
a particular information storage device that stores particular information;
an area-specific particular information storage device that stores area-specific particular information, the area-specific particular information associating the particular information with an area segment;
a vehicle information reception device that receives at least one of positional information and route information of the vehicle;
an area-specific threshold data extraction device that extracts area-specific threshold data of a corresponding area segment from the area-specific particular information, based on the reception by the vehicle information reception device;
a navigation assisting data generation device that generates navigation assisting data containing the area-specific particular information and the area-specific threshold data; and
a transmission device that sends the navigation assisting data to the vehicle, and
the vehicle comprising:
a position determination device that can determine a present position of the vehicle;
a communication device that communicates with the server;
a server information storage device that stores the navigation assisting data received from the server; and
a warning necessity determination device that determines whether or not a warning is necessary based on the area-specific threshold data and the area-specific particular information that are stored in the server information storage device; and
a warning-related output control device that controls at least one of a display of a symbol and an output of sound related to the warning based, on the determination made by the warning necessity determination device.
